(19) United States
(12) Patent Application Publication
(10) Pub. No.: US 2025/0251200 A1
(43) Pub. Date: Aug. 7, 2025

(54) SCALABLE CONDENSER WITH SINGLE USE MANIFOLD

(71) Applicant: Sunflower Therapeutics, PBC, Hingham, MA (US)

(72) Inventors: Kerry R. Love, Somerville, MA (US); John C. Love, Somerville, MA (US)

(21) Appl. No.: 19/046,016

(22) Filed: Feb. 5, 2025

Related U.S. Application Data
(60) Provisional application No. 63/550,533, filed on Feb. 6, 2024.

(51) Int. Cl. F28F 3/06; F25B 21/00; F25B 39/04; F28F 21/06

(52) U.S. Cl. CPC F28F 3/06; F25B 21/00; F25B 39/04; F28F 21/065

(57) ABSTRACT

A scalable device includes a platform and a manifold removably coupled with the platform. The platform includes one or more first members, each having a first surface and one or more fins protruding from the first surface. The manifold includes an inlet, an outlet and one or more bases between the inlet and outlet for flowing through a fluid. Each base is formed with a plurality of first grooves on an interior side of the manifold and one or more second grooves on an exterior side of the manifold. Each respective base is removably fitted on a corresponding first member of the platform to enhance heat transfer between the platform and a fluid flowing through the manifold.

### CROSS-REFERENCE TO RELATED APPLICATION(S)

This application claims priority to U.S. Patent Application No. 63/550,533, filed Feb. 6, 2024, which is incorporated herein by reference in its entirety.

### TECHNICAL FIELD

The present disclosure generally relates to systems and methods for condensing fluids.

### BACKGROUND

Biopharmaceuticals and vaccines are commonly produced or manufactured using a series of operations intended to express, recover, and stabilize proteins or other pharmaceutical ingredients as part of a manufacturing process. These operations involve the delivery, transfer, and disposal of one or more fluid media and buffers including combinations of salts, chemicals, and other substances intended to support specific steps in the production process. Examples of such operations include cell cultivation or fermentation, buffer exchange, chromatography, concentration, precipitation, separation, and crystallization.

In many cases, a fluid includes vapor that needs to be condensed. However, there are very few single use condensers on the market. Many existing condensers are made of glass or stainless steel. They are reusable and require validated cleaning procedures and means of sterilization. Glass parts are also a safety risk as they break easily. Moreover, scaling up condensers is challenging and often requires a large form factor. Currently available single use condensers are large and complicated. Incorrect installation and use are likely to cause mechanical failure or lead to user error.

Hence, there is a need for systems and methods that address the above-mentioned issues.

### SUMMARY

The present disclosure addresses the above-mentioned issues and/or other issues by providing scalable condensers that eliminate the needs for cleaning, sterilization, and validation, have higher condenser efficiencies, and can be installed in parallel and/or in series based on process performance requirements.

In various embodiments, the present disclosure provides a device including a platform and a manifold. The platform includes one or more first members, each having a first surface and one or more fins protruding from the first surface. The manifold is removably coupled with the platform and configured to enhance heat transfer between the platform and a fluid flowing through the manifold. The manifold includes an inlet, an outlet and one or more bases between the inlet and outlet. Each respective base in the one or more bases is removably fitted on a corresponding first member in the one or more first members of the platform. The respective base is formed with a plurality of first grooves on an interior side of the manifold and one or more second grooves on an exterior side of the manifold. Each of the plurality of first grooves is in fluidic communication with the inlet and outlet to allow the fluid to flow through. Each of the plurality of first grooves is adjacent to at least one second groove in the one or more second grooves. Each respective second groove in the one or more second grooves receives a corresponding fin in the one or more fins of the corresponding first member when the respective base of the manifold is fitted on the corresponding first member of the platform, thereby enhancing heat transfer between the fluid and the platform by increasing a surface area between the respective base of the manifold and the corresponding first member of the platform.

In some embodiments, the platform includes one or more first cooling assemblies operable to cool the one or more first members of the platform by heat conduction, heat convection, radiation, or any combination thereof.

In some embodiments, the one or more first cooling assemblies include one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, or any combination thereof.

In some embodiments, the one or more cooling assemblies are disposed on the one or more first members of the platform.

In some embodiments, the one or more fins of the corresponding first member of the platform include at least two, at least five, at least ten, at least fifteen, at least twenty, at least twenty-five, or at least thirty fins. In some embodiments, the one or more fins of the corresponding first member of the platform include more than thirty fins, more than forty fins, or more than fifty fins.

In some embodiments, the respective base is further formed with a first chamber adjacent to the inlet, and each of the plurality of first grooves is in fluidic communication with the inlet through the first chamber.

In some embodiments, the respective base is further formed with a second chamber adjacent to the outlet, and each of the plurality of first grooves is in fluidic communication with the outlet through the second chamber.

In some embodiments, the inlet, the outlet and the one or more bases are monolithically formed as a unitary piece.

In some embodiments, the unitary piece is formed by molding.

In some embodiments, the unitary piece is made of a material including nylon, polycarbonate, polypropylene, polysulfone, polyethylene or any combination thereof.

In some embodiments, at least a portion of the respective base of the manifold is corrugated to form the plurality of first grooves and the one or more second grooves.

In some embodiments, the number of the one or more second grooves formed on the respective base of the manifold is the same as the number of the one or more fins on the corresponding first member of the platform.

In some embodiments, the plurality of first grooves on the respective base of the manifold includes at least two, at least five, at least ten, at least fifteen, at least twenty, at least twenty-five, or at least thirty grooves.

In some embodiments, the one or more bases consist of a single base, the one or more first members consist of a single first member, and the manifold further includes a cover covering the single base between the inlet and outlet.

In some embodiments, the cover is attached to the single base or integrally formed with the single base.

In some embodiments, the cover has a thickness of about 0.05 mm to 1 mm, about 1 mm to 6 mm, about 2 mm to 8 mm, or about 3 mm to 10 mm.

In some embodiments, the cover is opposite to the plurality of first grooves formed on the single base of the manifold.

In some embodiments, the platform further includes a second member removably coupled with the manifold to retain the manifold, to allow heat transfer between the second member and the fluid through the cover, or both.

In some embodiments, the second member of the platform is rotatable with respect to the single first member of the platform.

In some embodiments, the second member of the platform is removably placed on the cover of the manifold.

In some embodiments, the platform further includes one or more second cooling assemblies operable to cool the second member by heat conduction, heat convection, radiation, or any combination thereof.

In some embodiments, the one or more second cooling assemblies include one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, or any combination thereof.

In some embodiments, the one or more second cooling assemblies are disposed on the second member.

In some embodiments, the manifold is disposable.

In some embodiments, the manifold is a single-use manifold.

In some embodiments, the device is a condenser.

In some embodiments, the fluid includes a vapor. At least a portion of the vapor is condensed to produce condensate that flows out through the inlet of the manifold. Remaining fluid, if any, flows out through the outlet of the manifold.

In some embodiments, the fluid further includes a gas.

In some embodiments, the portion of the vapor that is condensed is about 50% or more, about 60% or more, about 70% or more, about 80% or more, about 90% or more, or about 100%.

In some embodiments, the one or more first members of the platform include two first members, and the one or more bases of the manifold include two bases.

In some embodiments, the two bases are substantially symmetric to each other.

In various embodiments, the present disclosure provides a system including one or more devices disclosed herein.

In some embodiments, the one or more devices include a plurality of devices.

In some embodiments, the manifolds of at least a subset of the plurality of devices are fluidly connected to each other in series, the manifolds of at least a subset of the plurality of devices are fluidly connected to each other in parallel, or both.

The devices and systems of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the present disclosure. The accompanying drawings are not necessarily to scale. The specific design features of the present disclosure as disclosed herein, including, for example, specific dimensions, orientations, locations, and shapes will be determined in part by the particular intended application and use environment. In addition, the components illustrated in the figures are combinable in any useful number and combination.

In the drawings:

FIG. 1 schematically illustrates in a perspective view an exemplary device, in which a platform is in a closed configuration, in accordance with some exemplary embodiments of the present disclosure;

FIG. 2 schematically illustrates in a perspective view the exemplary device of FIG. 1, in which the platform is in an open configuration, in accordance with some exemplary embodiments of the present disclosure;

FIG. 3 schematically illustrates in a cutout view the exemplary device of FIG. 1 in accordance with some exemplary embodiments of the present disclosure;

FIG. 4 schematically illustrates in a perspective view an exemplary component of the platform of the exemplary device of FIG. 1 in accordance with some exemplary embodiments of the present disclosure;

FIG. 5 schematically illustrates in a perspective view an exemplary manifold of the exemplary device of FIG. 1 in accordance with some exemplary embodiments of the present disclosure;

FIG. 6 schematically illustrates in a partially cutout view along line 6-6 of FIG. 5.

FIG. 7 schematically illustrates in a perspective view an exemplary manifold in accordance with some exemplary embodiments of the present disclosure;

FIG. 8 schematically illustrates a condenser for condensing a vapor in accordance with some exemplary embodiments of the present disclosure;

FIG. 9 is a photograph illustrating an exemplary experimental setup of an exemplary device, in which a platform is in a closed configuration, in accordance with some exemplary embodiments of the present disclosure;

FIG. 10 is a photograph illustrating an exemplary experimental setup of the exemplary device of FIG. 9, in which the platform is in an open configuration, in accordance with some exemplary embodiments of the present disclosure.

FIG. 11 schematically illustrates in a perspective view an exemplary platform in accordance with some exemplary embodiments of the present disclosure; and

FIG. 12 schematically illustrates in a cross sectional view the exemplary device of FIG. 9 in accordance with some exemplary embodiments of the present disclosure.

### DETAILED DESCRIPTION

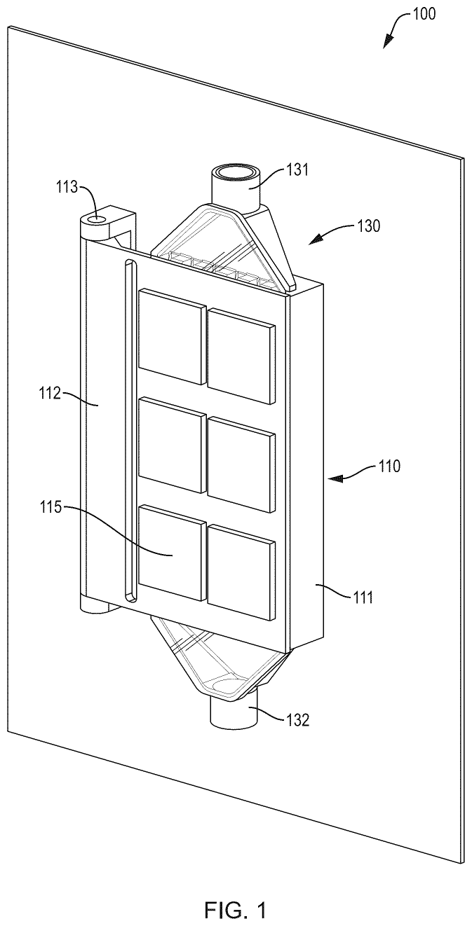

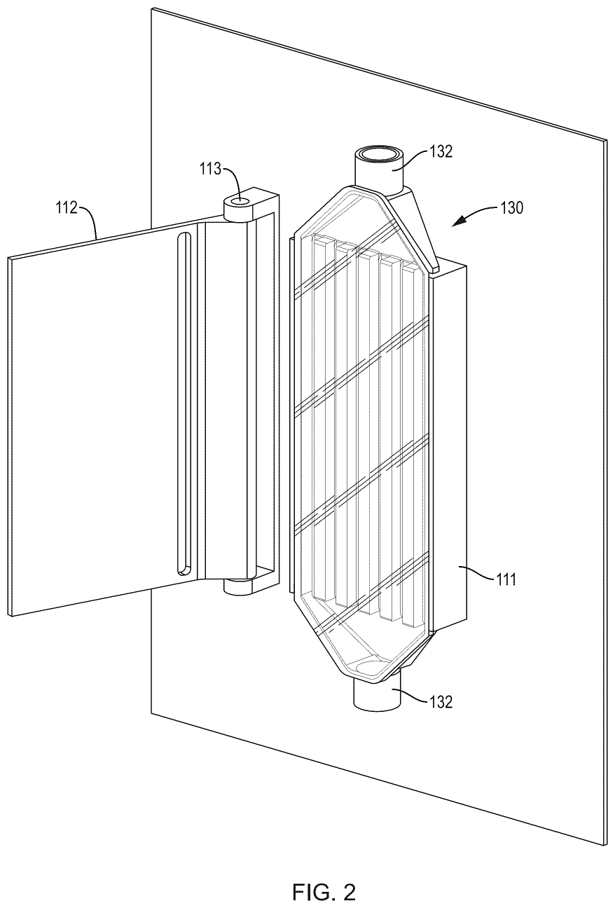

Referring now to the drawings, like reference numerals indicate like elements throughout. FIGS. 1-6 illustrate an exemplary device 100 in accordance with some exemplary embodiments of the present disclosure. The device 100 generally includes a manifold 130 for flowing a fluid therethrough, and a platform 110 for securing the manifold 130 and providing cooling to the fluid flowing through the manifold 130. The fluid may be in the form of gas, liquid, vapor, solution, or any mixture thereof. The platform 110 and the manifold 130 are configured to enhance heat transfer between the platform 110 and the fluid flowing through the manifold 130. The device 100 can be readily embedded into a system (e.g., installed on a chassis of the system with no or minimal need of additional hardware). For small load applications, a single device 100 may be sufficient. For large load applications, multiple devices 100 may be connected in series and/or in parallel.

The device 100 or the manifold 130 of the device 100 may have a form factor (e.g., in terms of shape, size, and/or capacity) significantly different than traditional condensers. For instance, the manifold 130 of the device 100 may be of a leaf structure, significantly different than traditional condensers, which either have columns for small load applications or complex structures for large load applications. The manifold 130 of the device 100 may also be of single use and/or disposable, whereas most traditional condensers require cleaning, sterilization, and validation before reusing them. With the single use manifold 130, certain embodiments of the present disclosure can eliminate the need for cleaning, sterilization, and validation.

In some embodiments, the platform 110 includes a first member 111 and a second member 112. The second member 112 may be movable relative to the first member 111. In some embodiments, first member 111 and second member 112 are movable relative to each other between an open configuration, e.g., for allowing the manifold 130 to be removed from platform 110, and a closed configuration, e.g., for securing manifold 130 to platform 110. For instance, the second member 112 may be connected (directly or indirectly) to the first member 111 through a mechanism 113 (e.g., hinge, latch, or the like) so that the second member 112 is rotatable relative to the first member 111. By moving (e.g., rotating) the second member 112, the platform 110 can be opened to receive or remove the manifold 130, and closed to secure the manifold 130 while the manifold 130 is in use. Second member 112 can be rotated about an axis of mechanism 113 (e.g., a hinge axis) in some such embodiments.

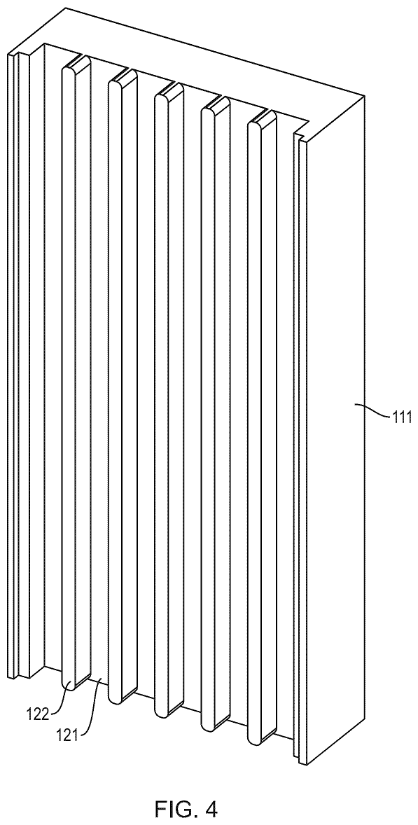

As particularly shown in FIG. 4, the first member 111 in some embodiments has a first surface 121 and one or more fins 122 protruding from the first surface 121. The one or more fins 122 may extend perpendicularly from first surface 121 according to some such embodiments. In some embodiments, the one or more fins 122 are parallel to the axis of mechanism 113 (e.g., hinge axis). The first member 111 may have any suitable number of fins. For instance, the first member 111 may have a single fin. Alternatively, the first member 111 may have at least two, at least five, at least ten, at least fifteen, at least twenty, at least twenty-five, or at least thirty fins. In some embodiments, the first member 111 may have include more than thirty fins, more than forty fins, or more than fifty fins. In some embodiments, the one or more fins 122 may include a plurality of fins (e.g., two or more fins) that are spaced apart and parallel to each other. In some embodiments, some or all of the one or more fins 122 extend the entire length of first member 111.

In some embodiments, the platform 110 includes one or more first cooling assemblies (e.g., like the cooling assembly 115 shown in FIG. 1). The one or more first cooling assemblies may provide active cooling or passive cooling. Passive cooling utilizes natural conduction, convection, and radiation to cool a component. Active cooling requires the use of energy specifically dedicated to cooling the component. The one or more first cooling assemblies are operable, for instance by a controller (which may be installed in the device 100 or in a system where the device 100 is embedded), to cool the first member 111 of the platform 110. The one or more first cooling assemblies may include one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, any other suitable cooling means, or any combination thereof. The one or more first cooling assemblies may cool the first member 111 of the platform 110 via heat conduction, heat convection, radiation, or any combination thereof. A first cooling assembly may be disposed on (e.g., fixed on, embedded in, or the like) the first member 111 of the platform 110. However, the present disclosure is not limited thereto. A first cooling assembly may be disposed on other components. In some embodiments, the one or more first cooling assemblies may be controlled to provide cooling in a controllable or programmable manner to the first member 111, and accordingly to provide cooling in a controllable or programmable manner to the fluid flowing through the manifold 130 placed in the platform 110.

In some embodiments, additionally or optionally, the platform 110 may include one or more second cooling assemblies 115. Like the one or more first cooling assemblies, the one or more second cooling assemblies 115 may be operable, for instance by a controller (which may be installed in the device 100 or a system where the device 100 is embedded), to cool the second member 112 of the platform 110. As with the one or more first cooling assemblies, the one or more second cooling assemblies 115 may provide active cooling or passive cooling. The one or more second cooling assemblies 115 may include, for example, one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, any other suitable cooling means, or any combination thereof. The one or more second cooling assemblies 115 may cool the second member 112 of the platform 110 via heat conduction, heat convection, radiation, or any combination thereof. A second cooling assembly may be disposed on (e.g., fixed on, embedded in, or the like) the second member 112 of the platform 110. However, the present disclosure is not limited thereto. A second cooling assembly may be disposed on other components. In some embodiments, the one or more second cooling assemblies 115 may be controlled to provide cooling in a controllable or programmable manner to the second member 112, and accordingly to provide cooling in a controllable or programmable manner to the fluid flowing through the manifold 130 placed in the platform 110.

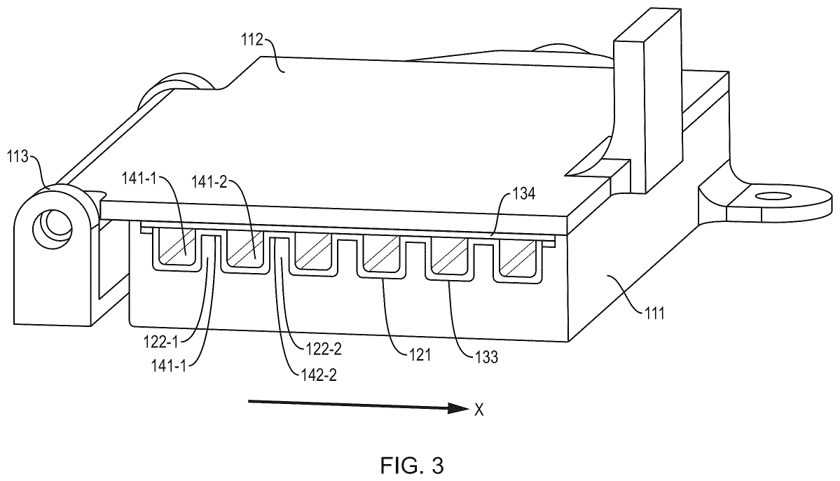

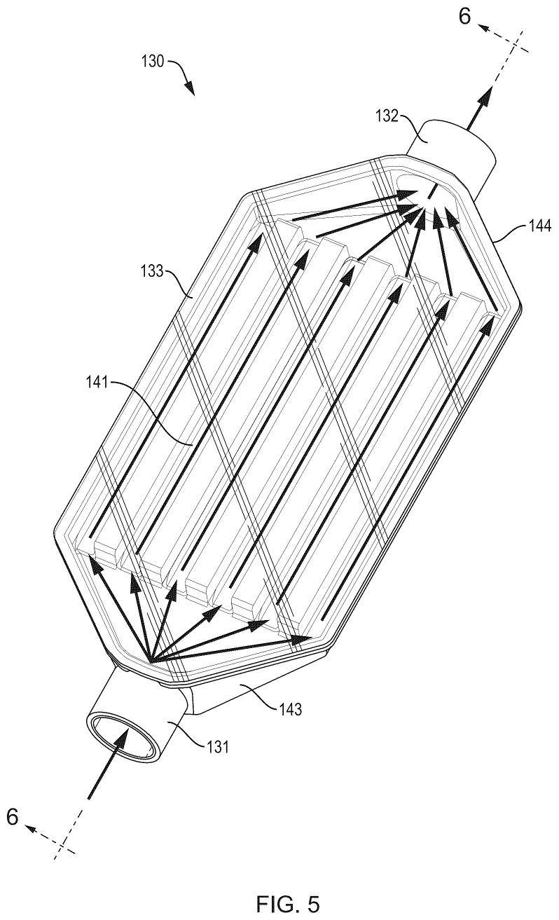

In some embodiments, the manifold 130 includes an inlet 131, an outlet 132 and a base 133 between the inlet 131 and outlet 132. The base 133 may be formed with a plurality of first grooves 141 on an interior side of the manifold 130 (i.e., the side facing the interior of the manifold 130) and one or more second grooves 142 on an exterior side of the manifold 130 (i.e., the side facing the exterior of the manifold 130). The base 133 can be formed with any suitable number of first grooves 141 and any suitable number of second grooves 142. For instance, in some embodiments, the base 133 may be formed with at least two, at least five, at least ten, at least fifteen, at least twenty, at least twenty-five, or at least thirty first grooves 141. As a non-limiting example, FIG. 5 illustrates a manifold 130 with six first grooves 141. As another non-limiting example, FIG. 7 illustrates a manifold 130 with three first grooves 141. The first and second grooves may have the same dimensions or different dimensions. For instance, in some embodiments, the first and second grooves may have the same width (e.g., the dimension in x-direction in FIG. 3) or different widths. In some embodiments, the plurality of first grooves 141 and the one or more second grooves 142 may be formed by corrugating the base 133 of the manifold 130 or corrugating a portion of the base 133 of the manifold 130.

Each of the plurality of first grooves 141 is in fluidic communication with the inlet 131 and the outlet 132 to allow the fluid to flow through. In some embodiments, the base 133 may be formed with a first chamber 143 adjacent to the inlet 131, and each of the plurality of first grooves 141 may be in fluidic communication with the inlet 131 through the first chamber 143. The first chamber 143 may be tapered or sloped to minimize flow resistance and/or allow for collection of condensates. Similarly, in some embodiments, the base 133 may be formed with a second chamber 144 adjacent to the outlet 132, and each of the plurality of first grooves 141 may be in fluidic communication with the outlet 132 through the second chamber 144. The second chamber 144 may be tapered or sloped. In some embodiments, the tapered or sloped shape of chamber 144 helps to funnel and/or direct condensates towards outlet 132.

Each of the plurality of first grooves 141 is adjacent to at least one second groove in the one or more second grooves 142. For instance, referring in particular to FIG. 3, the first groove 141-1 is adjacent to one second groove, i.e., the second groove 142-1, whereas the first groove 141-2 is adjacent to two second grooves 142, i.e., the second groove 142-1 and the second groove 142-2.

The one or more second grooves 142 formed on the base 133 of the manifold 130 may correspond to the one or more fins 122 formed on the first member 111 of the platform 110. For instance, the number of the one or more second grooves 142 may be the same as the number of the one or more fins 122 on the first member 111 of the platform 110 and the base 133 may be removably fitted on the first member 111 with each respective second groove in the one or more second grooves 142 receiving a corresponding fin in the one or more fins 122 of the first member 111 as illustrated in FIG. 3. This significantly increases the surface area (e.g., surface area of contact) between the respective base 133 of the manifold 130 and the corresponding first member 111 of the platform 110, and thus enhances heat transfer between the fluid (which flows through the manifold 130) and the platform 110. In some embodiments, one or more second grooves 142 may be configured to interdigitate or interlock with the one or more fins 122 when manifold 130 is engaged with platform 110.

The inlet 131, the outlet 132, and the base 133 may be monolithically formed as a unitary piece, for instance, by molding or the like. The unitary piece may be made of a material including a resin, a monomer, a polymer, a copolymer, other similar or suitable materials, or any combination thereof. In some embodiments, the unitary piece may be constructed from one or more thermoplastic polymers. For instance, the unitary piece may be made of a material including nylon, polycarbonate, polypropylene, polysulfone, polyethylene, or any combination thereof.

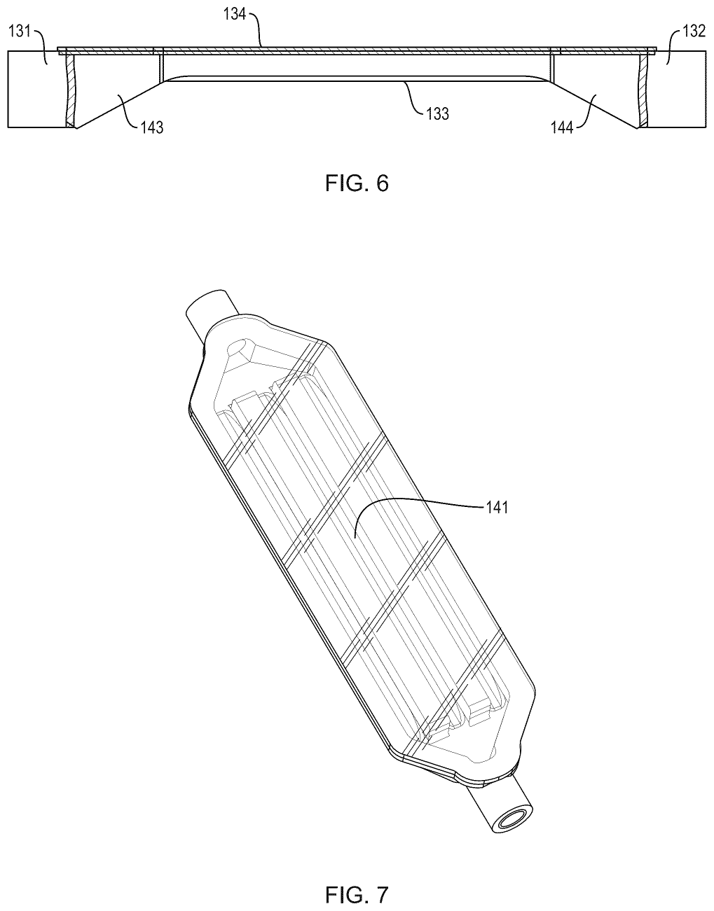

Referring in particular to FIGS. 3 and 6, in some embodiments, the manifold 130 includes a cover 134 that covers at least the base 133 between the inlet 131 and outlet 132. The cover 134 may be attached to the base 133 or integrally formed with the base 133. For instance, the cover 134 may be attached to the base 133 by laser welding, adhesive, ultrasonic welding, heat welding, or any other similar or suitable means. The cover 134 may have any suitable shape and size. In some embodiments, the cover 134 may be substantially planar and may have a thickness of about 0.05 mm to about 1 mm, about 1 mm to about 6 mm, about 2 mm to about 8 mm, or about 3 mm to about 10 mm. The cover 134 may be made of the same material as the base 133 or a different material. In some embodiments, the cover 134 is opposite to the plurality of first grooves 141 formed on the base 133 of the manifold 130.

When the platform 110 is closed, the second member 112 of the platform 110 may be positioned adjacent to the cover 134 of the manifold 130 or may be in contact with the cover 134 of the manifold 130. The second member 112 helps to retain the manifold 130 in place. In some embodiments where the platform 110 includes one or more second cooling assemblies 115, the second member 112 also allows heat transfer between the second member 112 and the fluid through the cover 134. The platform 110 or a portion of it may be insulated to present heat transfer between the platform and its environment. For instance, in some embodiments, the first member 111 and/or the second member 112 of the platform 110 may be insulated.

The interior of the manifold 130 may be treated to reduce surface tension of condensate. For instance, the interior of the manifold 130 may be treated with surface coating, SCOTCHGARD™ coating, nanocoating, or other treatment so that the vapor and/or condensate may not attach to the interior surfaces of the manifold 130 and may slide down (e.g., by the gravity) to the inlet 131 of the manifold 130. In some embodiments, one or more interior surfaces of manifold 130 may be treated or coated to increase the hydrophobicity, increase the non-wetting properties, and/or lower the surface energy of the surface.

Referring in particular to FIG. 5, the device 100 may be used as a condenser to cool vapors, causing them to condense into a liquid. For instance, in some embodiments, the fluid includes a vapor and flows into the manifold 130. With the presence of the plurality of first grooves 141, the fluid splits into multiple first grooves (or channels formed by the first grooves and the cover 134) that increase the condensing surface area. The fluid is cooled and at least a portion of the vapor in the fluid condenses inside first grooves (or channels). Condensates drip down into the first chamber 143 and out through the inlet 131 for collection or further processing. Remaining fluid, if any, flows out of the first grooves (or channels) into the second chamber 144 and out through the outlet 132. In some embodiments, remaining fluid, if any, flowing out through the outlet 132 of the manifold 130 may be circulated back into the inlet 131 of the manifold 130 or fed into the inlet 131 of another device 100 (e.g., two or more devices 100 are fluidly connected in series).

The condensed portion of the vapor may be about 50% or more, about 60% or more, about 70% or more, about 80% or more, about 90% or more, or about 100%. In some embodiments, a single device 100 may be sufficient to condense all the vapor in the fluid. In some embodiments, multiple devices 100 may be necessary for condensing all the vapor in the fluid. Multiple devices 100 may be fluidly connected to each other in series, in parallel, or both.

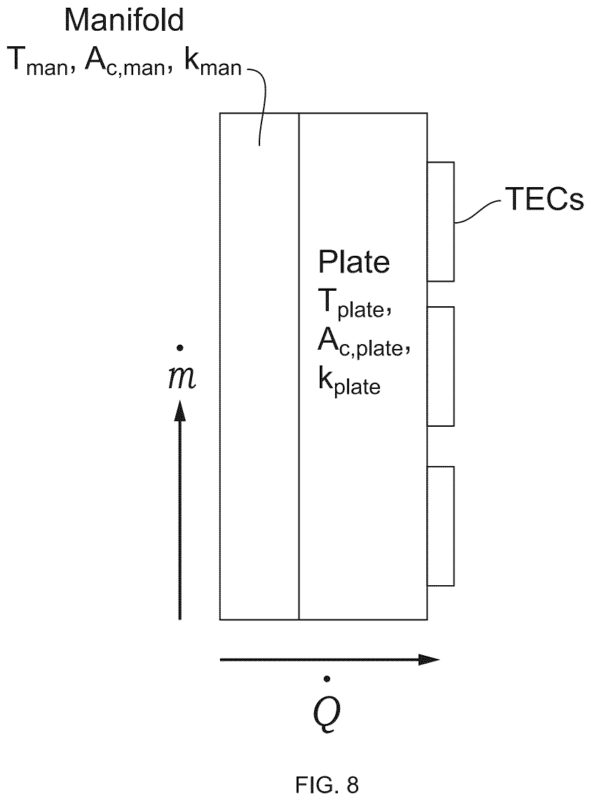

FIG. 8 illustrates a condenser for condensing a vapor in accordance with certain embodiments. The heat transfer needed to cool and condense the vapor and overcome the convection heat transfer from hot air may be calculated as follows:

$$\dot{Q} = {\dot{m}}_{v} {L}_{v} + {\dot{m}}_{air} {c}_{p , v} ( {T}_{op} - {T}_{v , sat} ) + {\dot{Q}}_{conv}$$

In the above equation, \dot{Q} denotes the heat transfer needed to cool and condense the vapor and overcome the convection heat transfer from environment (e.g., hot air). \dot{m}ᵥ denotes the mass flow rate of the vapor in the air entering the condenser. \dot{m}ₐᵢᵣ denotes the mass flow rate of the air entering the condenser. Lᵥ denotes the specific latent heat of vaporization of the vapor. c_{P,v} denotes the specific heat capacity of water at constant pressure. Tₒₚ denotes the operating temperature of the air entering the condenser. T_{v,sat} denotes the dew point of the vapor. \dot{Q}_{conv} denotes the convection heat transfer from environment.

The heat transfer from one side of the condenser (e.g., from one side of the platform) to the manifold may be calculated as follows:

$${R}_{condenser} = \frac{{t}_{man}}{{k}_{man} {A}_{man}} + \frac{{t}_{plate}}{{k}_{plate} {A}_{plate}} + {R}_{pad}$$

$${T}_{c} = {T}_{s} - {\dot{Q}}_{plate} {R}_{condenser}$$

In the above equations, \dot{Q}ₚₗₐₜₑ denotes the heat transfer from one side of the condenser (e.g., the platform) to the manifold. R_{condenser} denotes the thermal resistance of one side of the condenser. tₘₐₙ denotes the thickness of the manifold. kₘₐₙ denotes the thermal conductivity of the manifold. Aₘₐₙ denotes the cross-sectional area of the manifold. tₚₗₐₜₑ denotes the thickness of the cooling plate (e.g., the first or second member of the platform). kₚₗₐₜₑ denotes the thermal conductivity of the cooling plate. Aₚₗₐₜₑ denotes the cross-sectional area of the cooling plate. R_{pad} denotes the thermal resistance of the pad between the cooling plate and TECs (e.g., the first or second cooling assembly). T_{c} denotes the surface temperature of the cooling plate (e.g., cool side adjacent to the TECs). Tₛ denotes the surface temperature of the inside wall of the manifold.

As can be seen, increasing the surface area between the manifold and the platform (equivalent to increasing Aₘₐₙ and Aₚₗₐₜₑ) decreases the thermal resistance. As a result, it enhances the heat transfer between the platform and the manifold, and consequently increases the condenser efficiency.

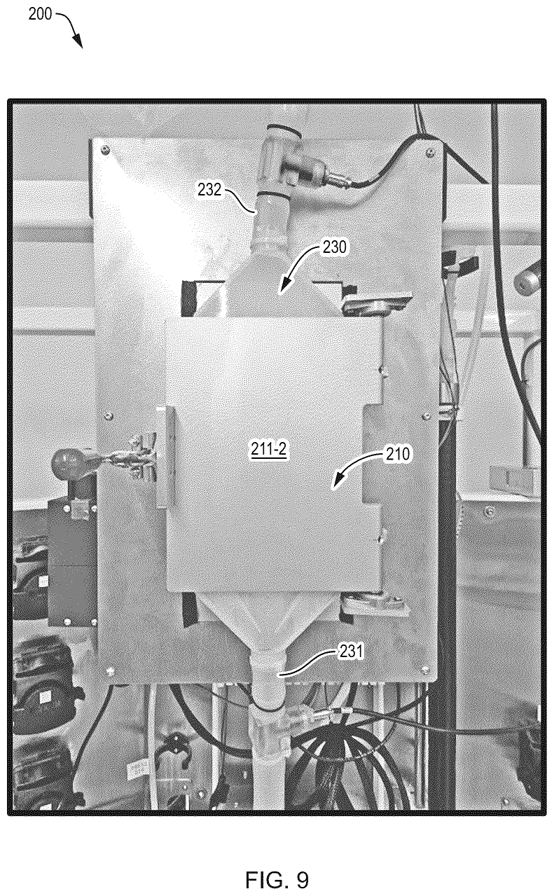

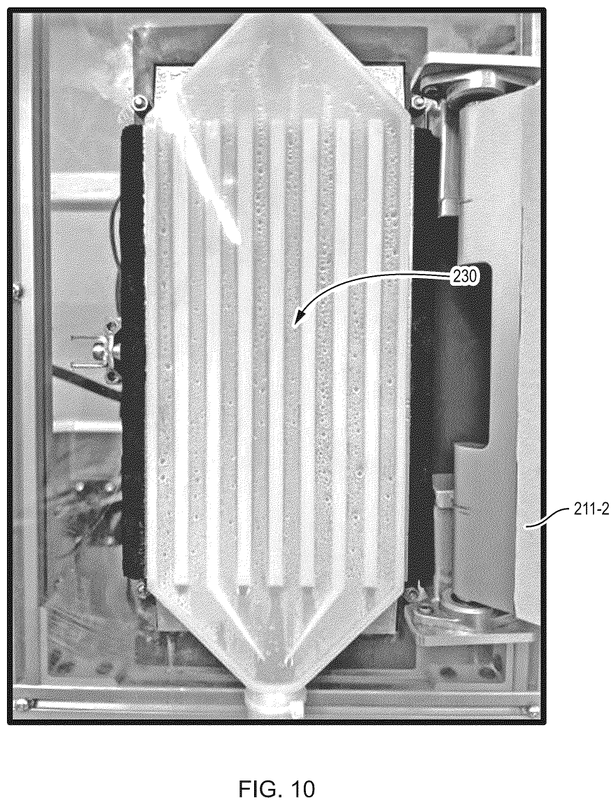

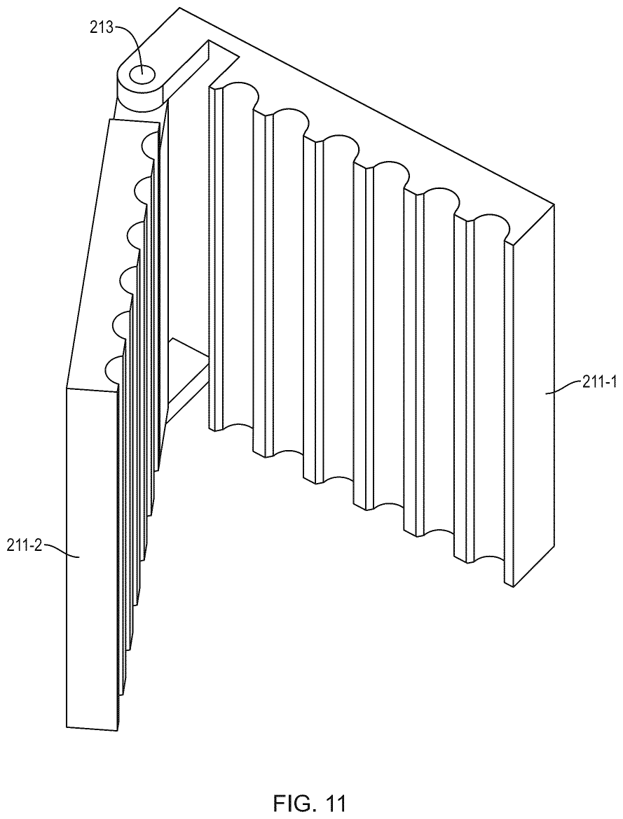

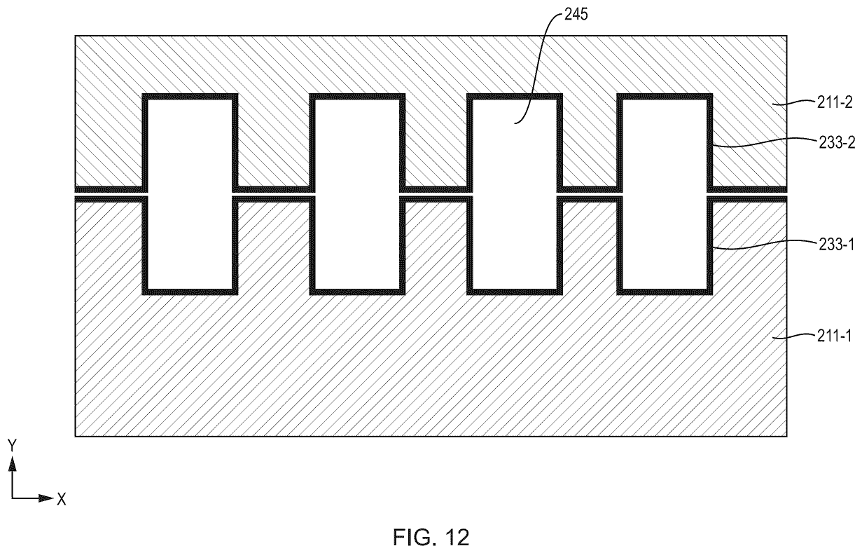

FIGS. 9-12 illustrate an exemplary device 200 in accordance with some exemplary embodiments of the present disclosure. Like the device 100, the device 200 generally includes a manifold 230 for flowing a fluid therethrough, and a platform 210 for securing the manifold 230 and providing cooling to the fluid flowing through the manifold 230. The platform 210 and the manifold 230 are configured to enhance heat transfer between the platform 210 and the fluid flowing through the manifold 230.

Like the device 100, the device 200 can be readily embedded into a system (e.g., installed on a chassis of the system with no or minimal need of additional hardware). For small load applications, a single device 200 may be sufficient. For large load applications, multiple devices 200 may be connected in series and/or in parallel. In addition, one or more devices 100 and one or more devices 200 may be connected in series and/or in parallel when desired.

The device 200 or the manifold 230 of the device 200 may have a form factor (e.g., in terms of shape, size, and/or capacity) significantly different than traditional condensers. For instance, the manifold 230 of the device 200 may be of a leaf structure, significantly different than traditional condensers, which either have columns for small load applications or complex structures for large load applications. The manifold 230 of the device 200 may also be of single use and/or disposable, whereas most traditional condensers require cleaning, sterilization, and validation before reusing them. With the single use manifold 230, certain embodiments of the present disclosure can eliminate the need for cleaning, sterilization, and validation.

In some embodiments, the platform 210 includes two first members 211-1 and 211-2 that may be movable relative to each other. In some embodiments, first member 211-1 and second member 211-2 are movable relative to each other between an open configuration, e.g., for allowing the manifold 230 to be removed from platform 210, and a closed configuration, e.g., for securing manifold 230 to platform 210. For instance, one first member (e.g., the first member 211-2) may be connected (directly or indirectly) to the other first member (e.g., the first member 211-2) through a mechanism 213 (e.g., hinge, latch, or the like) so that the one first member is rotatable relative to the other first member. By moving (e.g., rotating) one of the first members, the platform 210 can be opened to receive or remove the manifold 230, and closed to secure the manifold 230 while the manifold 230 is in use. Second member 211-2 can be rotated about an axis of mechanism 213 (e.g., a hinge axis) in some such embodiments.

In some embodiments, each first member 211 may be configured substantially the same as the first member 111 disclosed herein with respect to the device 100. For instance, in some embodiments, each first member 211 may include a surface and one or more fins protruding from the surface. To avoid redundancy, detailed description of the first member 211 is omitted. In some embodiments, the one or more fins are parallel to the axis of mechanism 213 (e.g., hinge axis). The two first members 211-1 and 211-2 may be configured substantially the same (e.g., including the same number of fins) and/or positioned substantially symmetrical to each other. However, the present disclosure is not limited thereto. The two first members 211-1 and 211-2 may be configured differently and positioned asymmetric relative to each other.

In some embodiments, the platform 210 includes one or more first cooling assemblies (e.g., cooling assembly like the cooling assembly 115 shown in FIG. 1) operable to cool each first member 211 of the platform 210 in a similar fashion as the one or more first cooling assemblies disclosed herein with respect to the device 100.

In some embodiments, the manifold 230 includes an inlet 231, an outlet 232 and two bases 233-1 and 233-2 between the inlet 231 and outlet 232. Each base 233 may be configured substantially the same as the base 133 disclosed herein with respect to the device 100. For instance, each base 233 may be formed with a plurality of first grooves on an interior side of the manifold 230 and one or more second grooves on an exterior side of the manifold 230. To avoid redundancy, detailed description of the base 233 is omitted. The two bases 233-1 and 233-2 may be configured substantially the same (e.g., including the same number of first grooves and the same number of second grooves) and/or positioned substantially symmetrical to each other. However, the present disclosure is not limited thereto. The two bases 233-1 and 233-2 may be configured differently and positioned asymmetric relative to each other.

In some embodiments, the inlet 231, the outlet 232, and one base 233 may be monolithically formed as a unitary piece, for instance, by molding or the like. The unitary piece may be made of a material including polycarbonate, polypropylene, polysulfone, polyethylene, or any other similar or suitable materials. The other base 233 may be attached to the one base 233, for instance, by laser welding, adhesive, ultrasonic welding, heat welding, or any other similar or suitable means. Alternatively, the two bases 233 may be monolithically formed as a unitary piece or coupled with each other and then connected to the inlet 231 and the outlet 232.

Referring in particular to FIG. 12, in some embodiments, the two bases 233-1 and 233-2 may be configured such that the first grooves of the two bases 233-1 and 233-2 are aligned with each other to form a plurality of channels 245. The first grooves of the two bases 233-1 and 233-2 may have substantially the same width (e.g., the dimension in the x-direction in FIG. 12). The first grooves of the two bases 233-1 and 233-2 may have substantially the same height (e.g., the dimension in the y-direction in FIG. 12), or different heights. Each channel 245 is surrounded by the fins or walls of the first members 211. As such, the first members 211 provide a substantially 360° cooling to the fluid flowing through the channel 245. This significantly enhances heat transfer between the fluid (which flows through the manifold 230) and the platform 210.

Like the device 100, the platform 210 may be insulated. The interior of the manifold 230 may be treated to reduce surface tension of condensate. For instance, the interior of the manifold 230 may be treated with surface coating, SCOTCHGARD™ coating, nanocoating, or other treatment so that the vapor and/or condensate may not attach to the interior surfaces of the manifold 230 and may slide down (e.g., by the gravity) to the inlet 231 of the manifold 230. In some embodiments, one or more interior surfaces of manifold 230 may be treated or coated to increase the hydrophobicity, increase the non-wetting properties, and/or lower the surface energy of the surface. The device 200 may be used as a condenser to cool vapors, causing them to condense into a liquid.

In some embodiments, one or more devices disclosed herein (e.g., the device 100 and/or the device 200) may be installed or embedded in a system. In some embodiments, a plurality of devices disclosed herein (e.g., the device 100 and/or the device 200) may be installed or embedded in a system. In some embodiments, the plurality of devices may include two or more such devices, three or more such devices, four or more such devices, or five or more such devices. In some embodiments, the plurality of devices may include ten or more such devices. In some embodiments, the manifolds of at least a subset of the plurality of devices are fluidly connected to each other in series. In some embodiments, the manifolds of at least a subset of the plurality of devices are fluidly connected to each other in parallel. In some embodiments, the manifolds of at least a subset of the plurality of devices are fluidly connected to each other in series, and the manifolds of at least a subset of the plurality of devices are fluidly connected to each other in parallel.

### TERMINOLOGIES AND REFERENCES CITED

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, “inward” or “outward” and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “include”, “includes”, “including”, “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “it” denotation, the reference number refers to a generic component, set, or embodiment. For instance, a “unit i” refers to the it unit in a plurality of units.

All references cited herein are incorporated herein by reference in their entirety and for all purposes to the same extent as if each individual publication or patent or patent application was specifically and individually indicated to be incorporated by reference in its entirety for all purposes.

What is claimed is:

1. A device comprising:
a platform comprising one or more first members, each of the one or more first members having a first surface and one or more fins protruding from the first surface; and
a manifold removably coupled with the platform and configured to enhance heat transfer between the platform and a fluid flowing through the manifold, the manifold comprising an inlet, an outlet and one or more bases between the inlet and outlet, wherein:
each respective base in the one or more bases is removably fitted on a corresponding first member in the one or more first members of the platform,
the respective base is formed with a plurality of first grooves on an interior side of the manifold and one or more second grooves on an exterior side of the manifold;
each of the plurality of first grooves is in fluidic communication with the inlet and the outlet to allow the fluid to flow through;
each of the plurality of first grooves is adjacent to at least one second groove in the one or more second grooves; and
each respective second groove in the one or more second grooves receives a corresponding fin in the one or more fins of the corresponding first member when the respective base of the manifold is fitted on the corresponding first member of the platform, thereby enhancing heat transfer between the fluid and the platform by increasing a surface area between the respective base of the manifold and the corresponding first member of the platform.

2. The device of claim 1, wherein the platform comprises one or more first cooling assemblies operable to cool the one or more first members of the platform by heat conduction, heat convection, radiation, or any combination thereof.

3. The device of claim 2, wherein the one or more first cooling assemblies comprise one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, or any combination thereof.

4. The device of claim 2, wherein the one or more first cooling assemblies are disposed on the one or more first members of the platform.

5. The device of claim 1, wherein:
the respective base is further formed with a first chamber adjacent to the inlet; and
each of the plurality of first grooves is in fluidic communication with the inlet through the first chamber.

6. The device of claim 1, wherein:
the respective base is further formed with a second chamber adjacent to the outlet; and
each of the plurality of first grooves is in fluidic communication with the outlet through the second chamber.

7. The device of claim 1, wherein the inlet, the outlet and the one or more bases are monolithically formed as a unitary piece.

8. The device of claim 7, wherein the unitary piece is made of a material comprising nylon, polycarbonate, polypropylene, polysulfone, polyethylene, or any combination thereof.

9. The device of claim 1, wherein at least a portion of the respective base of the manifold is corrugated to form the plurality of first grooves and the one or more second grooves.

10. The device of claim 1, wherein the number of the one or more second grooves formed on the respective base of the manifold is the same as the number of the one or more fins on the corresponding first member of the platform.

11. The device of claim 1, wherein:
the one or more bases consist of a single base;
the one or more first members consist of a single first member; and
the manifold further comprises a cover covering the single base between the inlet and the outlet.

12. The device of claim 11, wherein the cover is opposite to the plurality of first grooves formed on the single base of the manifold.

13. The device of claim 11, wherein the platform further comprises a second member removably coupled with the manifold to retain the manifold, to allow heat transfer between the second member and the fluid through the cover, or both.

14. The device of claim 13, wherein the second member of the platform is rotatable with respect to the single first member of the platform.

15. The device of claim 13, wherein the second member of the platform is removably placed on the cover of the manifold.

16. The device of claim 13, wherein the platform further comprises one or more second cooling assemblies operable to cool the second member by heat conduction, heat convection, radiation, or any combination thereof.

17. The device of claim 16, wherein the one or more second cooling assemblies comprise one or more thermoelectric coolers, one or more direct-to-air thermoelectric cooling assemblies, one or more direct-to-liquid thermoelectric cooling assemblies, direct liquid cooling, air cooling, one or more fans, one or more heatsinks, or any combination thereof.

18. The device of claim 16, wherein the one or more second cooling assemblies are disposed on the second member.

19. A system comprising a plurality of devices of claim 1.

20. The system of claim 19, wherein:
the manifolds of at least a subset of the plurality of devices are fluidly connected to each other in series;
the manifolds of at least a subset of the plurality of devices are fluidly connected to each other in parallel; or
both.
